(19) United States
(12) Patent Application Publication
(10) Pub. No.: US 2026/0169227 A1
(43) Pub. Date: Jun. 18, 2026

(54) Hollow Core Fiber to Single Mode Fiber Connectors

(71) Applicant: II0VI Photonics, Inc., Fuzhou (CN)

(72) Inventors: Tingyu Xue, Fuzhou (CN); Baozhong Zheng, Fuzhou (CN); Yang Li, Fuzhou (CN); Wuli Zhao, Fuzhou (CN); Yunbing Xu, Fuzhou (CN); Yajun Wang, Santa Clara, CA (US); Yingkan Chen, Fuzhou (CN); Xuchen Huang, Fuzhou (CN); Chunyan Jia, Fuzhou (CN)

(21) Appl. No.: 19/004,540

(22) Filed: Dec. 30, 2024

(30) Foreign Application Priority Data
Dec. 13, 2024 (CN) 202411837104.8

(51) Int. Cl. G02B 6/38; G02B 6/26; G02B 6/32; G02B 6/34

(52) U.S. Cl. CPC G02B 6/3801; G02B 6/262; G02B 6/32; G02B 6/34

(57) ABSTRACT

A hollow core fiber (HCF) and single mode fiber (SMF) coupling system includes a HCF that is positioned in a first inner housing; a SMF that has been exposed to thermal expanded core (TEC) treatment and is positioned in a second inner housing, wherein the SMF is in tandem with the HCF in the first inner housing; and a first and a second inner housing.

### CROSS-REFERENCE TO RELATED APPLICATION

This application claims priority to Chinese Patent Application No. 202411837104.8 filed Dec. 13, 2024, the disclosure of which is hereby incorporated by reference in its entirety.

### BACKGROUND

### Field

The present disclosure is directed connectors for fibers in telecommunications, and, in particular, to devices, assemblies, and systems comprising hollow core fiber to single mode fiber connectors.

### Description of Related Art

Hollow core fiber (HCF) is a kind of optical fiber with a specific designed hollow structure, preferred for future high-speed communication and data center networks, in part because of advantages of zero dispersion and low latency. However, due to the limitations of technological maturity, HCFs are currently unable to be deployed throughout an entire communication chain.

Therefore, HCFs may be utilized in conjunction with other conventional fibers such as solid single mode fibers (SMFs), that are widely used in traditional communication and data center network links. A primary issue that needs to be addressed is how to achieve low insertion loss and return loss connections between the HCFs and SMFs.

In the academic community, various connection schemes for conventional solid SMFs and HCFs based on fiber fusion or splicing technology have been proposed. However, due to the limitations of technological maturity, fusion/splicing solutions are difficult to meet the requirements of low insertion loss and high return loss simultaneously.

The subject matter of the present disclosure is directed to achieving such connections that have low insertion loss and high return loss. Such connections may meet the return loss requirement of 50 dB.

### SUMMARY

According to non-limiting embodiments or aspects, provided is a hollow core fiber (HCF) and single mode fiber (SMF) coupling system comprising: a HCF that is positioned in a first inner housing; a SMF that has been exposed to thermal expanded core (TEC) treatment and is positioned in a second inner housing, the SMF is in tandem with the HCF in the first inner housing; and a first and a second inner housing.

In non-limiting embodiments or aspects, the coupling system further comprising: an outer housing that surrounds at least a portion of the first inner housing and second inner housing. In non-limiting embodiments or aspects, the outer housing comprises a tube or ferrule. In non-limiting embodiments or aspects, the first and second inner housing comprise a capillary. In non-limiting embodiments or aspects, the SMF and second inner housing comprise a SMF pigtail and the HCF and first inner housing comprise a HCF pigtail, and the SMF pigtail and HCF pigtail are fixed to the outer housing via fastening means after alignment. In non-limiting embodiments or aspects, the SMF pigtail comprises a terminal end where the SMF terminates, and the terminal end is polished to an inclined end surface of about 0 to 5° from a vertical plane. In non-limiting embodiments or aspects, the terminal end includes an anti-reflective (AR) coating. In non-limiting embodiments or aspects, the SMF pigtail has a mode field diameter that is about the same as a mode field diameter of the HCF pigtail.

According to non-limiting embodiments or aspects, provided is a hollow core fiber (HCF) and single mode fiber (SMF) coupling system comprising: a HCF that is positioned in a first inner housing; a SMF and multi-mode fiber (MMF) in communication with each other forming a SMF-MMF system, the SMF-MMF system is positioned in a second inner housing, the SMF-MMF system is in tandem with the HCF in the first inner housing; and a first and a second inner housing. In non-limiting embodiments or aspects, the MMF comprises a graded index multi-mode fiber that has a mode field diameter that is about the same size as a mode field diameter of the HCF. In non-limiting embodiments or aspects, the SMF has a mode field diameter, and the MMF expands the mode field diameter of the SMF to about the same as the mode field diameter of the HCF. In non-limiting embodiments or aspects, the MMF comprises a graded index multi-mode fiber with length in a quarter the fiber pitch. In non-limiting embodiments or aspects, the coupling system further comprising: an outer housing that surrounds at least a portion of the first inner housing and second inner housing. In non-limiting embodiments or aspects, the SMF-MMF system and second inner housing comprise a SMF pigtail and the HCF and first inner housing comprise a HCF pigtail, and the SMF pigtail and HCF pigtail are fixed to the outer housing via fastening means after alignment. In non-limiting embodiments or aspects, the SMF pigtail comprises a terminal end where the MMF terminates, and the terminal end is polished to an inclined end surface of about 0 to 5° from a vertical plane.

According to non-limiting embodiments or aspects, provided is a hollow core fiber (HCF) and single mode fiber (SMF) coupling system comprising: a HCF that is positioned in a first inner housing; a SMF that is positioned in a second inner housing, the SMF is in tandem with the HCF in the first inner housing; a first micro-lens that is positioned in between the HCF and SMF; and a first and a second inner housing. In non-limiting embodiments or aspects, the coupling system further comprising: an outer housing that surrounds at least a portion of the first inner housing and second inner housing, the first micro-lens is positioned in the outer housing. In non-limiting embodiments or aspects, the SMF and second inner housing comprise a SMF pigtail and the HCF and first inner housing comprise a HCF pigtail, and the SMF pigtail and HCF pigtail are fixed to the outer housing via fastening means after alignment. In non-limiting embodiments or aspects, the SMF pigtail comprises a terminal end where the SMF terminates, and the terminal end is polished to an inclined end surface of about 0 to 5° from a vertical plane. In non-limiting embodiments or aspects, the first micro-lens is selected from the group consisting of: c-lenses or single convex lens with tilted plane, graded-index (grin) lenses, d-lenses or biconvex lens, or combinations thereof. In non-limiting embodiments or aspects, the first micro-lens is configured to convert and/or adapt a mode field diameter of the SMF and/or HCF, thereby promoting a mode field diameter match between the SMF and HCF. In non-limiting embodiments or aspects, the coupling system has an insertion loss of about less than or equal to 0.5 dB. In non-limiting embodiments or aspects, the coupling system has a return loss of about greater than or equal to 50 dB.

In non-limiting embodiments or aspects, the coupling system further comprising: a first intermediate housing positioned at least partially surrounding the first inner housing and HCF; the first micro-lens is positioned within the first inner housing proximate to the HCF, and the HCF, first inner housing, first intermediate housing and first micro-lens comprise a HCF collimator. In non-limiting embodiments or aspects, the coupling system further comprising: a second intermediate housing positioned at least partially surrounding the second inner housing and SMF; and a second micro-lens positioned within the second inner housing proximate to the SMF; the SMF, second inner housing, second intermediate housing, and second micro-lens comprise a SMF collimator. In non-limiting embodiments or aspects, the coupling system has an insertion loss of about less than or equal to 0.5 dB. In non-limiting embodiments or aspects, the coupling system further comprising: an outer housing that surrounds at least a portion of the first intermediate housing, the first intermediate housing is configured to be positioned at a location within the outer housing that minimizes the insertion loss.

In non-limiting embodiments or aspects, the first and second micro-lenses are configured to convert and/or adapt a mode field diameter of the SMF and/or HCF, thereby promoting mode field diameter match between the SMF and HCF. In non-limiting embodiments or aspects, the SMF and second inner housing comprise an SMF terminal end proximate to the second micro-lens, the SMF terminal end is polished to an inclined end surface. In non-limiting embodiments or aspects, the second micro-lens comprises a micro-lens terminal end proximate to the SMF, the micro-lens terminal end is polished to an inclined end surface of about 0 to 5° from a vertical plane. In non-limiting embodiments or aspects, the SMF and/or micro-lens terminal ends include an anti-reflective (AR) coating.

In non-limiting embodiments or aspects, the coupling system further comprising: a diagonal prism positioned in between the HCF collimator and the SMF collimator. In non-limiting embodiments or aspects, the diagonal prism comprises two non-parallel end faces, the diagonal prism configured to improve lateral offset and/or angular mismatch between the HCF collimator and the SMF collimator. In non-limiting embodiments or aspects, the first and second micro-lens are selected from the group consisting of: c-lenses or single convex lens with tilted plane, graded-index (grin) lenses, d-lenses or biconvex lens, or combinations thereof.

Non-limiting examples of the present disclosure will now be described in the following numbered clauses:

Clause 1: A hollow core fiber (HCF) and single mode fiber (SMF) coupling system comprising: a HCF that is positioned in a first inner housing; a SMF that has been exposed to thermal expanded core (TEC) treatment and is positioned in a second inner housing, wherein the SMF is in tandem with the HCF in the first inner housing; and a first and a second inner housing.

Clause 2: The coupling system of clause 1, further comprising: an outer housing that surrounds at least a portion of the first inner housing and second inner housing.

Clause 3: The coupling system of any of clauses 1-2, wherein the outer housing comprises a tube or ferrule.

Clause 4: The coupling system of any of clauses 1-3, wherein the first and second inner housing comprise a capillary.

Clause 5: The coupling system of any of clauses 1-4, wherein the SMF and second inner housing comprise a SMF pigtail and wherein the HCF and first inner housing comprise a HCF pigtail, and wherein the SMF pigtail and HCF pigtail are fixed to the outer housing via fastening means after alignment.

Clause 6: The coupling system of any of clauses 1-5, wherein the SMF pigtail comprises a terminal end where the SMF terminates, and wherein the terminal end is polished to an inclined end surface of about 0 to 5° from a vertical plane.

Clause 7: The coupling system of any of clauses 1-6, wherein the terminal end includes an anti-reflective (AR) coating.

Clause 8: The coupling system of any of clauses 1-7, wherein the SMF pigtail has a mode field diameter that is about the same as a mode field diameter of the HCF pigtail.

Clause 9: A hollow core fiber (HCF) and single mode fiber (SMF) coupling system comprising: a HCF that is positioned in a first inner housing; a SMF and multi-mode fiber (MMF) in communication with each other forming a SMF-MMF system, wherein the SMF-MMF system is positioned in a second inner housing, wherein the SMF-MMF system is in tandem with the HCF in the first inner housing; and a first and a second inner housing.

Clause 10: The coupling system of clause 9, wherein the MMF comprises a graded index multi-mode fiber that has a mode field diameter that is about the same size as a mode field diameter of the HCF.

Clause 11: The coupling system of any of clauses 9-10, wherein the SMF has a mode field diameter, and wherein the MMF expands the mode field diameter of the SMF to about the same as the mode field diameter of the HCF.

Clause 12: The coupling system of any of clauses 9-11, wherein the MMF comprises a graded index multi-mode fiber with length in a quarter the fiber pitch.

Clause 13: The coupling system of any of clauses 9-12, further comprising: an outer housing that surrounds at least a portion of the first inner housing and second inner housing.

Clause 14: The coupling system of any of clauses 9-13, wherein the SMF-MMF system and second inner housing comprise a SMF pigtail and wherein the HCF and first inner housing comprise a HCF pigtail, and wherein the SMF pigtail and HCF pigtail are fixed to the outer housing via fastening means after alignment.

Clause 15: The coupling system of any of clauses 9-14, wherein the SMF pigtail comprises a terminal end where the MMF terminates, and wherein the terminal end is polished to an inclined end surface of about 0 to 5° from a vertical plane.

Clause 16: A hollow core fiber (HCF) and single mode fiber (SMF) coupling system comprising: a HCF that is positioned in a first inner housing; a SMF that is positioned in a second inner housing, wherein the SMF is in tandem with the HCF in the first inner housing; a first micro-lens that is positioned in between the HCF and SMF; and a first and a second inner housing.

Clause 17: The coupling system of clause 16, further comprising: an outer housing that surrounds at least a portion of the first inner housing and second inner housing, wherein the first micro-lens is positioned in the outer housing.

Clause 18: The coupling system of any of clauses 16-17, wherein the SMF and second inner housing comprise a SMF pigtail and wherein the HCF and first inner housing comprise a HCF pigtail, and wherein the SMF pigtail and HCF pigtail are fixed to the outer housing via fastening means after alignment.

Clause 19: The coupling system of any of clauses 16-18, wherein the SMF pigtail comprises a terminal end where the SMF terminates, and wherein the terminal end is polished to an inclined end surface of about 0 to 5° from a vertical plane.

Clause 20: The coupling system of any of clauses 16-19, wherein the first micro-lens is selected from the group consisting of: c-lenses or single convex lens with tilted plane, graded-index (grin) lenses, d-lenses or biconvex lens, or combinations thereof.

Clause 21: The coupling system of any of clauses 16-20, wherein the first micro-lens is configured to convert and/or adapt a mode field diameter of the SMF and/or HCF, thereby promoting mode field diameter match between the SMF and HCF.

Clause 22: The coupling system of any of clauses 16-21, wherein the coupling system has an insertion loss of about less than or equal to 0.5 dB.

Clause 23: The coupling system of any of clauses 16-22, wherein the coupling system has a return loss of about greater than or equal to 50 dB.

Clause 24: The coupling system of any of clauses 16-23, further comprising: a first intermediate housing positioned at least partially surrounding the first inner housing and HCF; wherein the first micro-lens is positioned within the first inner housing proximate to the HCF, and wherein the HCF, first inner housing, first intermediate housing and first micro-lens comprise a HCF collimator.

Clause 25: The coupling system of any of clauses 16-24, further comprising: a second intermediate housing positioned at least partially surrounding the second inner housing and SMF; and a second micro-lens positioned within the second inner housing proximate to the SMF; wherein the SMF, second inner housing, second intermediate housing, and second micro-lens comprise a SMF collimator.

Clause 26: The coupling system of any of clauses 16-25, wherein the coupling system has an insertion loss of about less than or equal to 0.5 dB.

Clause 27: The coupling system of any of clauses 16-26, further comprising: an outer housing that surrounds at least a portion of the first intermediate housing, wherein the first intermediate housing is configured to be positioned at a location within the outer housing that minimizes the insertion loss.

Clause 28: The coupling system of any of clauses 16-27, wherein the first and second micro-lenses are configured to convert and/or adapt a mode field diameter of the SMF and/or HCF, thereby promoting mode field diameter match between the SMF and HCF.

Clause 29: The coupling system of any of clauses 16-28, wherein the SMF and second inner housing comprise an SMF terminal end proximate to the second micro-lens, wherein the SMF terminal end is polished to an inclined end surface.

Clause 30: The coupling system of any of clauses 16-29, wherein the second micro-lens comprises a micro-lens terminal end proximate to the SMF, wherein the micro-lens terminal end is polished to an inclined end surface of about 0 to 5° from a vertical plane.

Clause 31: The coupling system of any of clauses 16-30, wherein the SMF and/or micro-lens terminal ends include an anti-reflective (AR) coating.

Clause 32: The coupling system of any of clauses 16-31, further comprising: a diagonal prism positioned in between the HCF collimator and the SMF collimator.

Clause 33: The coupling system of any of clauses 16-32, wherein the diagonal prism comprises two non-parallel end faces, wherein the diagonal prism configured to improve lateral offset and/or angular mismatch between the HCF collimator and the SMF collimator.

Clause 34: The coupling system of any of clauses 16-33, wherein the first and second micro-lens are selected from the group consisting of: c-lenses or single convex lens with tilted plane, graded-index (grin) lenses, d-lenses or biconvex lens, or combinations thereof.

### BRIEF DESCRIPTION OF THE DRAWINGS

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limit of the invention.

FIG. 1A is a side schematic drawing of an SMF-HCF connector shown before a fiber thermal expanded core (TEC) treatment according to an aspect of the present disclosure,

FIG. 1B is a side schematic drawing of an SMF-HCF connector shown after a TEC treatment,

FIG. 1C is a profile of experimental return loss for the SMF-HCF connector of FIG. 1B;

FIG. 2A is a side profile of the mode field diameter of the SMF in FIG. 1B,

FIG. 2B is the cross-section of the mode field diameter of the HCF in FIG. 1A,

FIG. 3A is a side schematic drawing of an SMF-HCF connector shown before a graded index multi-mode fiber is connected to an SMF according to an aspect of the present disclosure,

FIG. 3B is a side schematic drawing of an SMF-HCF connector shown after including a graded index multi-mode fiber;

FIG. 4 is a side schematic drawing of an HCF-SMF connector according to an aspect of the present disclosure;

FIG. 5A is a side schematic drawing of an HCF-SMF connector according to an aspect of the present disclosure,

FIG. 5B is a profile of experimental return loss for the SMF-HCF connector of FIG. 5A;

FIG. 6 is a side schematic drawing of an HCF-SMF connector according to an aspect of the present disclosure; and

FIG. 7 is a side schematic drawing of a system with two SMF-HCF connectors according to an aspect of the present disclosure.

### DETAILED DESCRIPTION

As used herein, the singular form of “a”, “an”, and “the” include plural referents unless the context clearly dictates otherwise. For the purposes of this specification, unless otherwise indicated, all numbers expressing quantities of ingredients, reaction conditions, dimensions, physical characteristics, and so forth used in the specification and claims are to be understood as being modified in all instances by the term “about.”

As used herein, the terms “right”, “left”, “top”, and derivatives thereof shall relate to the invention as it is oriented in the drawing figures. However, it is to be understood that the invention can assume various alternative orientations and, accordingly, such terms are not to be considered as limiting. Also, it is to be understood that the invention can assume various alternative variations and stage sequences, except where expressly specified to the contrary. It is also to be understood that the specific devices and processes illustrated in the attached drawings, and described in the following specification, are examples. Hence, specific dimensions and other physical characteristics related to the embodiments disclosed herein are not to be considered as limiting.

Also, it should be understood that any numerical range recited herein is intended to include all sub-ranges subsumed therein. For example, a range of “1 to 10” is intended to include any and all sub-ranges between and including the recited minimum value of 1 and the recited maximum value of 10, that is, all sub-ranges beginning with a minimum value equal to or greater than 1 and ending with a maximum value equal to or less than 10, and all sub-ranges in-between, e.g., 1 to 6.3, or 5.5 to 10, or 2.7 to 6.1.

The present disclosure is directed to connection schemes between HCF and conventional solid SMF by using free space micro-optical coupling approaches. Disclosed methods for low insertion loss may include mode field diameter (MFD) conversion and adapting between SMF to HCF by using fiber thermal expanded core (TEC) treatment, graded index multi-mode fiber or tailor-made micro-lens and other optical elements. Disclosed methods for high return loss may include adopting inclined plane and anti-reflective (AR) coating on each surface of optical elements. These solutions can simultaneously realize the high performances of low insertion loss and high return loss for the connection between hollow core fiber (HCF) and single-mode fiber (SMF).

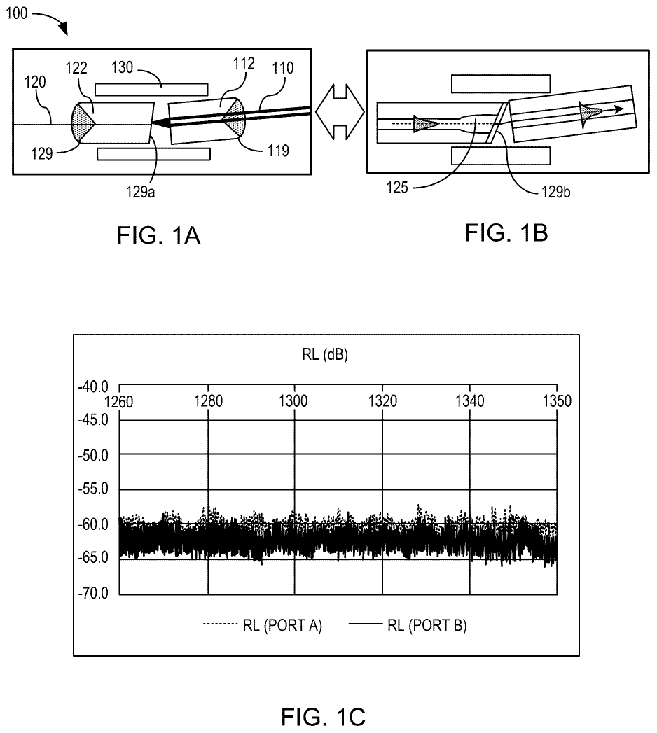

Referring initially to FIG. 1A and FIG. 1B, side schematic drawings of an SMF-HCF connector 100 is shown. In FIG. 1A, the SMF-HCF connector has not yet been exposed to a fiber thermal expanded core (TEC) treatment and in FIG. 1B, the SMF-HCF connector is shown after a TEC treatment.

In both FIGS. 1A and 1B, a SMF-HCF adapter structure or connector 100 is provided that combines an HCF 110 and a SMF 120. HCF 110 is housed in a first inner housing 112, which in some embodiments, is translucent, transparent, or opaque to light. For example, first inner housing 112 may comprise a capillary fabricated from glass, ceramic, metal, plastic or the like.

HCF 110 generally comprises a mode field diameter DM1 of about 15 to 30 μm. In contrast, the SMF 120 generally comprises a mode field diameter DM2 of about 5 to 15 μm. For example, D2 may be about 10 μm for 1550 nm and 9 μm for 1320 nm wavelength. Mode field diameter is herein defined as twice the mode radius and defined for gaussian beams emitting from the fiber end, where the mode radius (or beam radius) is the radius where the intensity has dropped to 1/e2 of the intensity on the beam axis. For a specific fiber, the mode field diameter usually varies with wavelength.

It should be appreciated that one of the reasons that SMF and HCF have not been able to be used together easily before is due to the differences in mode field diameter. As presented above, mode field diameter relates to type, optical design (usually geometric design) and working wavelength of fiber, but in reality, is a limitation for different principles of light conduction and different geometric configuration between SMF and HCF that cause the MFD difference. MFD transition and matching needs to be made in SMF-HCF connector design.

SMF 120 is housed in a second inner housing 122, which in some embodiments, is opaque, translucent or transparent to light. For example, second inner housing 122 may comprise a capillary fabricated from glass, ceramic, metal, plastic or the like.

Also shown partially surrounding first inner housing 112 and second inner housing 122 is an outer housing 130. In some non-limiting aspects or embodiments, outer housing 130 comprises a tube or ferrule, fabricated from glass, ceramic, metal, plastic or the like.

In FIG. 1B, the SMF 120 has been exposed to a TEC, which causes the mode field diameter of an exposed portion 125 of SMF 120 to be about the same as the mode field diameter DM1 of HCF 110.

As is known, the dopant in the core of fiber will diffuse to the cladding when the heating temperature exceeds about 1300° C. This phenomenon is called thermal expanded core (TEC). It is usually used to expand the core diameter of a single core fiber (here single mode fiber in our invention). A TEC fiber usually consist of step-index region, tapered region and expanded region.

For example, in some embodiments, the SMF 120 includes a fiber core and a cladding. During TEC, the SMF 120 may be exposed to a temperature of about 1300° C. for a predetermined time to cause a dopant in the fiber core to diffuse to the cladding.

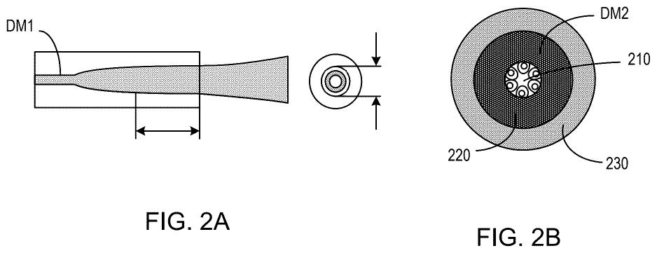

As shown in FIG. 2A, a side profile and end profile of the mode field diameter of the SMF in FIG. 1B is provided. This is comparable to the cross-section of the mode field diameter of the HCF in FIG. 1A, as shown in FIG. 2B. As described above, mode field diameter is twice the mode field radius and related to the radius of gaussian beam which the fiber can convey. A center ring illustrates cladding layer 220, and an outer ring illustrates coating layer 230; the mode field diameter DM2 is smaller than the diameter of the ring region which illustrates fiber core 210 in FIG. 2B.

Referring back to FIGS. 1A and 1B, in some non-limiting aspects or embodiments, the SMF 120 in the second inner housing 122 is in tandem with the HCF 110 in the first inner housing 112. In other embodiments, the SMF 120 and HCF 110 are aligned with each other such that the fibers can communicate via connector 100.

In some non-limiting aspects or embodiments, the SMF 120 and second inner housing 122 form a “SMF pigtail” 129. In some embodiments, the HCF 110 and first inner housing 112 form a “HCF pigtail” 119. The SMF pigtail 129 and HCF pigtail 119 may be fixed to the outer housing 130 via a fastening means after they are aligned. Suitable fastening means include epoxies, mechanical fasteners, welding, etc.

In some non-limiting aspects or embodiments, the SMF pigtail 129 includes a terminal end 129a, where the SMF terminates or ends within outer housing 130. Terminal end 129a may be polished to an inclined surface of about 0 to 5° from a vertical plane. In other words, the terminal end 129a may be set to an incline that deviates about up to 5° from if it had been cut as a blunt end.

While not wishing to be bound by any particular theory, providing an inclined terminal end 129a helps promote a high return loss. For example, if the terminal end 129a is a plane without any inclination angle and AR coating, the overall component will suffer from a 3% back energy flow brings by the beam reflection in the air glass interface of fiber end. And this 3% back energy flow is equivalent to 15 dB in return loss, which is too small compared to a desired value of 50 dB. Furthermore, the inclined terminal end 129a may further include an anti-reflecting (AR) coating 129b. As an example, if the terminal end 129a is a plane without any inclination angle, but has an AR coating attached, then the return loss caused by back energy flow would be 30 dB, also smaller than the desired value. Thus, both an inclined angle and AR coating contribute to a higher return loss.

In some non-limiting aspects or embodiments, the AR coating 129b may be selected from any suitable anti-reflective group, such as magnesium fluoride. The thickness of the coating may vary in thickness depending on the working wavelength and coating design. In some embodiments, the thickness of the coating is dependent on the working wavelength of light being used in connector 100, for example, 1320 nm or 1550 nm.

By introducing TEC fiber and an inclined surface, the mode field diameter matching condition between the SMF 120 and HCF 110 can be met and the requirement of low insertion loss and high return loss can be simultaneously realized. For example, low insertion loss on the range of about ≤0.5 dB and/or high return loss on the range of about ≥50 dB for a center wavelength of about 1310 nm may be achieved.

Turning briefly to FIG. 1C, a profile of experimental return loss for the SMF-HCF connector 100 of FIG. 1B is shown. The return loss shown is better than about −55 dB.

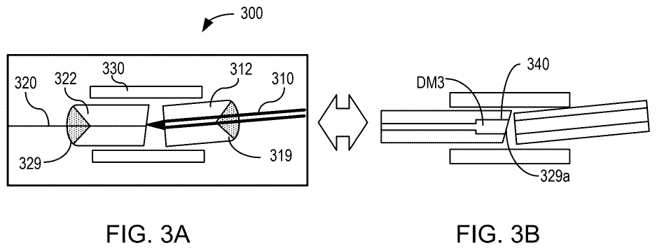

Referring now to FIG. 3A and FIG. 3B, side schematic drawings of an SMF-HCF connector is shown. In FIG. 3A, the SMF-HCF connector shown before a graded index multi-mode fiber is connected to an SMF according to an aspect of the present disclosure and FIG. 3B is a side schematic drawing of an SMF-HCF connector shown after including a graded index multi-mode fiber.

In both FIGS. 3A and 3B, a SMF-HCF adapter structure or connector 300 is provided that combines a HCF 310 and a SMF 320. HCF 310 is housed in a first inner housing 312, which in some embodiments, is opaque, translucent or transparent to light. For example, first inner housing 312 may comprise a capillary fabricated from glass, ceramic, metal, plastic or the like.

Similar to FIG. 1, HCF 310 generally comprises a mode field diameter DM1 of about 15 to 30 μm. and the SMF 320 generally comprises a mode field diameter DM2 of about 5 to 15 μm.

SMF 320 is housed in a second inner housing 322, which in some embodiments, is opaque, translucent or transparent to light. For example, second inner housing 322 may comprise a capillary fabricated from glass, ceramic, metal, plastic or the like. Also shown partially surrounding first inner housing 312 and second inner housing 322 is an outer housing 330. In some non-limiting aspects or embodiments, outer housing 330 comprises a tube or ferrule, fabricated from glass, ceramic, metal, plastic or the like.

In FIG. 3B, the SMF 320 is in communication with a graded index multi-mode fiber (MMF) 340. The graded index MMF 340 may be any suitable type of multi-mode fiber. In some embodiments, the graded index MMF 340 has a mode field diameter DM3 of about 15 to 30 μm, roughly the same size as the mode field diameter DM1 of HCF 310. In some embodiments, the graded index MMF 340 expands the mode field diameter DM2 of the SMF 320 to about the same as the mode field diameter DM1 of the HCF 310.

For example, single mode fiber fusion with a short, graded index multi-mode fiber is a substitute for TEC fiber of FIG. 1, which also expands the mode field diameter of single mode fiber to the mode field diameter of hollow core fiber to realize mode field diameter matching. The length of this short, graded index multi-mode fiber may be set a quarter (¼) length of fiber pitch. The pitch of graded index multi-mode fiber is defined as axial length of one cycle of fiber path. ¼ pitch length graded index multi-mode fiber may serve as a mode field diameter expander like the TEC fiber.

In some non-limiting aspects or embodiments, the SMF 320 and graded index MMF 340 in the second inner housing 322 are in tandem with the HCF 310 in the first inner housing 312. In other embodiments, the SMF 320 and graded index MMF 340 and HCF 310 are aligned with each other such that the fibers can communicate via connector 300.

In some non-limiting aspects or embodiments, the SMF 320, graded index MMF 340 and second inner housing 322 form a “SMF pigtail” 329. In some embodiments, the HCF 310 and first inner housing 312 form a “HCF pigtail” 319. The SMF pigtail 329 and HCF pigtail 319 may be fixed to the outer housing 330 via a fastening means after they are aligned. Suitable fastening means include epoxies, mechanical fasteners, welding etc.

In some non-limiting aspects or embodiments, the SMF pigtail 329 includes a terminal end 329a, where the SMF 320 and graded index MMF 340 combination terminates or ends within outer housing 330. Terminal end 329a may be polished to an inclined surface of about 0 to 5° from a vertical plane. In other words, the terminal end 329a may be set to an incline that deviates about up to 5° from if it had been cut as a blunt end.

Similar to the discussion of FIG. 1, providing an inclined terminal end 329a helps promote a high return loss. Furthermore, the inclined terminal end 329a may further include an anti-reflecting (AR) coating (not shown).

In some non-limiting aspects or embodiments, the AR coating may be selected from any suitable anti-reflective group, such as magnesium fluoride. In some embodiments, the thickness of the coating is dependent on the working wavelength of light being used in connector 300, for example, 1320 nm or 1550 nm.

By introducing graded index MMF and an inclined surface, the mode field diameter matching condition between the SMF 320 and HCF 310 can be met and the requirement of low insertion loss and high return loss can be simultaneously realized. For example, low insertion loss on the range of about ≤0.5 dB and/or high return loss on the range of about ≥50 dB for a center wavelength of about 1310 nm may be achieved.

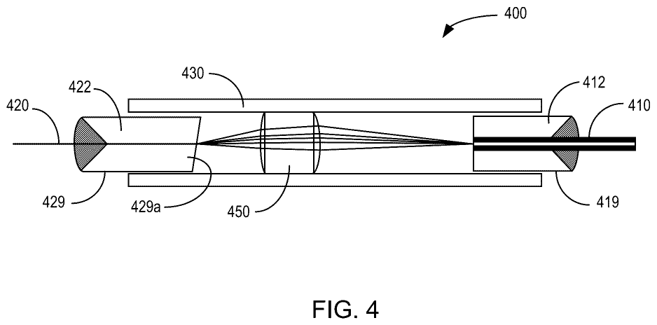

Referring now to FIG. 4, a side schematic drawing of an SMF-HCF connector 400 according to an aspect of the present disclosure is shown. SMF-HCF adapter structure or connector 400 combines an HCF 410 and a SMF 420. HCF 410 is housed in a first inner housing 412, which in some embodiments, is opaque, translucent or transparent to light. For example, first inner housing 412 may comprise a capillary fabricated from glass, ceramic, metal, plastic or the like.

Similar to previously disclosed embodiments, HCF 410 generally comprises a mode field diameter DM1 of about 15 to 30 μm. In contrast, the SMF 420 generally comprises a mode field diameter DM2 of about 5 to 15 μm.

SMF 420 is housed in a second inner housing 422, which in some embodiments, is opaque, translucent or transparent to light. For example, second inner housing 422 may comprise a capillary fabricated from glass, ceramic, metal, plastic or the like. Also shown partially surrounding first inner housing 412 and second inner housing 422 is an outer housing 430. In some non-limiting aspects or embodiments, outer housing 430 comprises a tube or ferrule.

In some non-limiting aspects or embodiments, the SMF 420 in the second inner housing 422 in tandem with the HCF 410 in the first inner housing 412. In other embodiments, the SMF 420 and HCF 410 are aligned with each other such that the fibers can communicate via connector 400.

In some non-limiting aspects or embodiments, the SMF 420 and second inner housing 422 form a “SMF pigtail” 429. In some embodiments, the HCF 410 and first inner housing 412 form a “HCF pigtail” 419. The SMF pigtail 429 and HCF pigtail 419 may be fixed to the outer housing 430 via a fastening means after they are aligned. Suitable fastening means include epoxies, mechanical fasteners, welding, etc.

In some non-limiting aspects or embodiments, the SMF pigtail 429 includes a terminal end 429a, where the SMF terminates or ends within outer housing 430. Terminal end 429a may be polished to an inclined surface of about 0 to 5° from a vertical plane. In other words, the terminal end 429a may be set to an incline that deviates about up to 5° from if it had been cut as a blunt end.

Inclined terminal end 429a may further include an anti-reflecting (AR) coating (not shown). In some non-limiting aspects or embodiments, the AR coating may be selected from any suitable anti-reflective group, such as magnesium fluoride. In some embodiments, the thickness of the coating is dependent on the working wavelength of light being used in connector 400, for example, 1320 nm or 1550 nm.

Also shown in FIG. 4, is a micro-lens 450 that is positioned in between the SMF pigtail 429 and HCF pigtail 419. In some non-limiting aspects or embodiments, SMF pigtail 429 and HCF pigtail 419 are coupled via micro-lens 450 and are positioned into outer housing 430 via a fastening means after they are aligned.

In some embodiments, outer housing 430 surrounds at least a portion of the first inner housing 412 and second inner housing 422, and the micro-lens 450 is positioned in the outer housing 430.

Micro-lens 450 may be selected from any suitable lens, including from group consisting of: c-lenses or single convex lens with tilted plane, graded-index (grin) lenses, d-lenses or biconvex lens, or combinations thereof. In some non-limiting aspects or embodiments, micro-lens 450 may have a diameter about equal to the diameter of SMF pigtail 429 and/or HCF pigtail 419.

In some embodiments, micro-lens 450 may be moved along the horizontal axis in between the SMF pigtail 429 and HCF pigtail 419, as desired. For example, the micro-lens 450 may be configured to convert and/or adapt a mode field diameter of the SMF 420 and/or HCF 410, thereby promoting mode field diameter match between the SMF 420 and HCF 410. This may be achieved by placement of micro-lens 450 in between the SMF 420 and HCF 410 and/or through lens, curvature and size selection, etc.

By introducing a micro-lens and an inclined surface, the mode field diameter matching condition between the SMF 420 and HCF 410 can be met and the requirement of low insertion loss and high return loss can be simultaneously realized. For example, low insertion loss on the range of about ≤0.5 dB and/or high return loss on the range of about ≥50 dB for a center wavelength of about 1310 nm may be achieved.

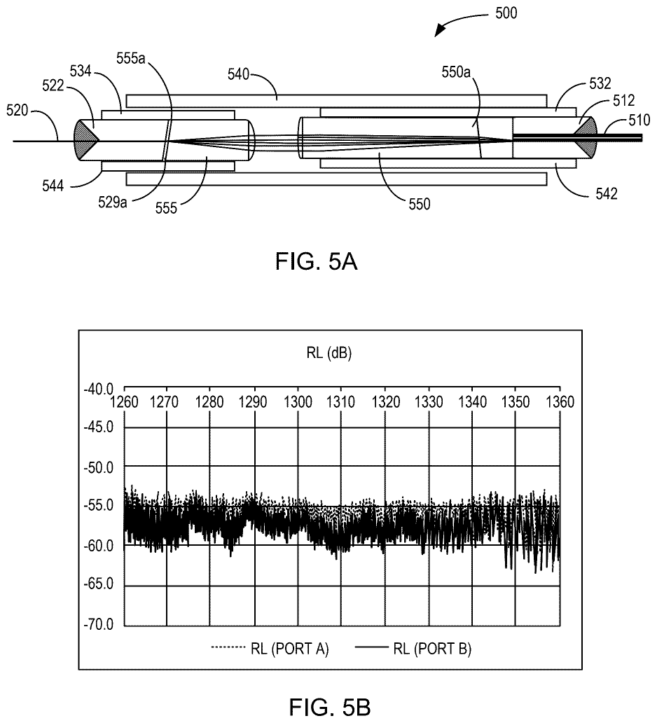

Referring now to FIG. 5A, a side schematic drawing of an SMF-HCF connector 500 according to an aspect of the present disclosure is shown. SMF-HCF adapter structure or connector 500 combines an HCF 510 and a SMF 520. HCF 510 is housed in a first inner housing 512, which in some embodiments, is opaque, translucent or transparent to light. For example, first inner housing 512 may comprise a capillary fabricated from glass, ceramic, metal, plastic or the like.

Similar to previously disclosed embodiments, HCF 510 generally comprises a mode field diameter DM1 of about 15 to 30 μm. In contrast, the SMF 520 generally comprises a mode field diameter DM2 of about 5 to 15 μm.

SMF 520 is housed in a second inner housing 522, which in some embodiments, is opaque, translucent or transparent to light. For example, second inner housing 522 may comprise a capillary fabricated from glass, ceramic, metal, plastic or the like. Also shown partially surrounding first inner housing 512 and HCF 510 is a first intermediate housing 532. Similarly, partially surrounding second inner housing 522 and SMF 520 is a second intermediate housing 534. In some non-limiting aspects or embodiments, first and/or second intermediate housing 532, 534 comprise a capillary fabricated from glass, ceramic, metal, plastic or the like.

In some non-limiting aspects or embodiments, the SMF 520 in the second inner housing 522 is in tandem with the HCF 510 in the first inner housing 512. In other embodiments, the SMF 520 and HCF 510 are aligned with each other such that the fibers can communicate via connector 500.

In some non-limiting aspects or embodiments, the SMF 520 and second inner housing 522 includes a terminal end 529a, where the SMF 520 terminates or ends within second intermediate housing 534. Terminal end 529a may be polished to an inclined surface of about 0 to 8° from a vertical plane. In other words, the terminal end 529a may be set to an incline that deviates about up to 8° from if it had been cut as a blunt end, because the beam radius of the gaussian beam differs from a bare fiber, as in previous embodiments. Thus, different tilt angles (i.e., inclined terminal end) can be modified to meet a described return loss. Inclined terminal end 529a may further include an anti-reflecting (AR) coating.

Inclined terminal end 529a may further include an anti-reflecting (AR) coating (not shown). In some non-limiting aspects or embodiments, the AR coating may be selected from any suitable anti-reflective group, such as magnesium fluoride. The thickness of the coating may vary in thickness depending on the working wavelength and coating design. In some embodiments, the thickness of the coating is dependent on the working wavelength of light being used in connector 500, for example, 1320 nm or 1550 nm.

Also shown in FIG. 5A, is a first micro-lens 550 that is positioned within the first inner housing 512 and proximate to the HCF 510. First micro-lens 550 may be selected from any suitable lens, including from group consisting of: c-lenses or single convex lens with tilted plane, graded-index (grin) lenses, d-lenses or biconvex lens, or combinations thereof. In some non-limiting aspects or embodiments, micro-lens 550 may have a diameter about equal to the diameter of inner housing 512, 522.

In some embodiments, first micro-lens 550 may include a terminal end 550a. Terminal end 550a may be polished to an inclined surface of about 0 to 8° from a vertical plane. In other words, the terminal end 550a may be set to an incline that deviates about up to 8° from if it had been cut as a blunt end. Inclined terminal end 550a may further include an anti-reflecting (AR) coating (not shown) of suitable thickness and material to minimize the total insertion loss of the connector 500.

In some non-limiting aspects or embodiments, HCF 510, first inner housing 512, first intermediate housing 532 and first micro-lens 550 form a HCF collimator 542. As shown in FIG. 5, HCF collimator 542 is laterally shifted a small distance from the SMF collimator 544 to minimize insertion loss. These components may be aligned and fixed together via a suitable fastening means, such as epoxies, mechanical fasteners, welding etc.

Also shown in FIG. 5A, is a second micro-lens 555 that is positioned within the second inner housing 522 and proximate to the SMF 520. Second micro-lens 555 may be selected from any suitable lens, including from group consisting of: c-lenses or single convex lens with tilted plane, graded-index (grin) lenses, d-lenses or biconvex lens, or combinations thereof. In some non-limiting aspects or embodiments, micro-lens 555 may have a diameter equal to about the diameter of inner housing 522, thereby facilitating assembly, for example.

In some embodiments, second micro-lens 555 may include a terminal end 555a. Terminal end 555a may be polished to an inclined surface of about 0 to 8° from a vertical plane. In other words, the terminal end 555a may be set to an incline that deviates about up to 8° from if it had been cut as a blunt end because the beam radius of the gaussian beam differs from a bare fiber, as in previous embodiments. Thus, different tilt angles (i.e., inclined terminal end) can be modified to meet a described return loss. Inclined terminal end 555a may further include an anti-reflecting (AR) coating.

As shown, terminal end 555a may be complementary angled with terminal end 529a, such that each terminal end has a similar inclined surface in the opposite direction, making the terminal end 555a parallel to terminal end 529a. Thus, the inclined angle of these two surfaces (i.e., 529a, 555a) may be set to make sure that the return loss of the overall component is larger (greater) than the desired threshold. In some non-limiting aspects or embodiments, SMF 520, second inner housing 522, second intermediate housing 534 and second micro-lens 555 form a SMF collimator 544. These components may be aligned and fixed together via a suitable fastening means, such as epoxies, mechanical fasteners, welding, etc.

Both the HCF collimator 542 and the SMF collimator 544 may be positioned into outer housing 540 via a fastening means after they are aligned. Consequently, the outer housing 540 surrounds at least a portion of the first intermediate housing 532 and at least a portion of the second intermediate housing 534.

In some embodiments, the first intermediate housing 532 may be configured to be positioned at a location within the outer housing 540 that minimizes insertion loss. For example, first intermediate housing 532 may be moved along the horizontal axis (e.g., laterally shifted a distance) to fine tune the insertion loss of the connector 500 to a lowest or desired value.

Additionally, the micro-lenses 550, 555 may be configured to convert and/or adapt a mode field diameter of the SMF 520 and/or HCF 510, thereby promoting mode field diameter match between the SMF 520 and HCF 510. This may be achieved by placement of micro-lenses 550, 555 in between the SMF 520 and HCF 510 and/or through lens, curvature and size selection, etc.

By introducing micro-lenses and inclined surfaces, the mode field diameter matching condition between the SMF 520 and HCF 510 can be met and the requirement of low insertion loss and high return loss can be simultaneously realized. For example, low insertion loss on the range of about ≤0.5 dB and/or high return loss on the range of about ≥50 dB for a center wavelength of about 1310 nm may be achieved.

Turning briefly to FIG. 5B, a profile of experimental return loss for the SMF-HCF connector 500 of FIG. 5A is shown. The return loss shown is better than about −50 dB.

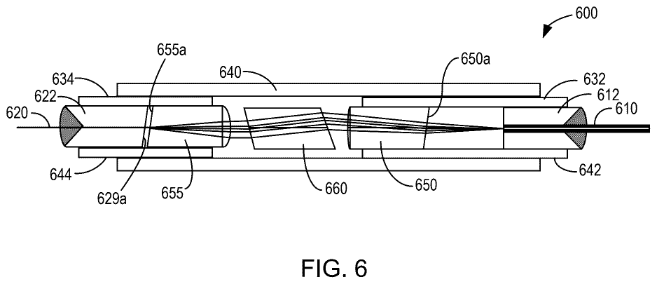

Referring now to FIG. 6, a side schematic drawing of an SMF-HCF connector 600 according to an aspect of the present disclosure is shown. SMF-HCF adapter structure or connector 600 combines an HCF 610 and a SMF 620. HCF 610 is housed in a first inner housing 612, which in some embodiments, is opaque, translucent or transparent to light. For example, first inner housing 612 may comprise a capillary fabricated from glass, ceramic, metal, plastic or the like.

Similar to previously disclosed embodiments, HCF 610 generally comprises a mode field diameter DM1 of about 15 to 30 μm. In contrast, the SMF 620 generally comprises a mode field diameter DM2 of about 5 to 15 μm.

SMF 620 is housed in a second inner housing 622, which in some embodiments, is opaque, translucent or transparent to light. For example, second inner housing 622 may comprise a capillary fabricated from glass, ceramic, metal, plastic or the like. Also shown partially surrounding first inner housing 612 and HCF 610 is a first intermediate housing 632. Similarly, partially surrounding second inner housing 622 and SMF 620 is a second intermediate housing 634. In some non-limiting aspects or embodiments, first and/or second intermediate housing 632, 634 comprise a capillary fabricated from glass, ceramic, metal, plastic or the like.

In some non-limiting aspects or embodiments, the SMF 620 in the second inner housing 622 is in tandem with the HCF 610 in the first inner housing 612. In other embodiments, the SMF 620 and HCF 610 are aligned with each other such that the fibers can communicate via connector 600.

In some non-limiting aspects or embodiments, the SMF 620 and second inner housing 622 includes a terminal end 629a, where the SMF 620 terminates or ends within second intermediate housing 634. Terminal end 629a may be polished to an inclined surface of about 0 to 8° from a vertical plane. In other words, the terminal end 629a may be set to an incline that deviates about up to 8° from if it had been cut as a blunt end.

Inclined terminal end 629a may further include an anti-reflecting (AR) coating (not shown). In some non-limiting aspects or embodiments, the AR coating may be selected from any suitable anti-reflective group, such as magnesium fluoride. The thickness of the coating may vary in thickness depending on the working wavelength and coating design. In some embodiments, the thickness of the coating is dependent on the working wavelength of light being used in connector 600, for example, 1320 nm or 1550 nm.

Also shown in FIG. 6, is a first micro-lens 650 that is positioned within the first inner housing 612 and proximate to the HCF 610. First micro-lens 650 may be selected from any suitable lens, including from a group consisting of: c-lenses or single convex lens with tilted plane, graded-index (grin) lenses, d-lenses or biconvex lens, or combinations thereof. In some non-limiting aspects or embodiments, micro-lens 650 may have a diameter that is about the same size as the diameter of inner housing 612, 622.

In some embodiments, first micro-lens 650 may include a terminal end 650a. Terminal end 650a may be polished to an inclined surface of about 0 to 5° from a vertical plane. In other words, the terminal end 650a may be set to an incline that deviates about up to 5° from if it had been cut as a blunt end. Inclined terminal end 650a may further include an anti-reflecting (AR) coating (not shown) of suitable thickness and material to minimize the total insertion loss of connector 600.

In some non-limiting aspects or embodiments, HCF 610, first inner housing 612, first intermediate housing 632 and first micro-lens 650 form a HCF collimator 642. These components may be aligned and fixed together via a suitable fastening means, such as epoxies, mechanical fasteners, etc.

Also shown in FIG. 6, is a second micro-lens 655 that is positioned within the second inner housing 622 and proximate to the SMF 620. Second micro-lens 655 may be selected from any suitable lens, including from a group consisting of: c-lenses or single convex lens with tilted plane, graded-index (grin) lenses, d-lenses or biconvex lens, or combinations thereof. In some non-limiting aspects or embodiments, micro-lens 655 may have a diameter that is about the same size as the diameter of inner housing 612, 622.

In some embodiments, second micro-lens 655 may include a terminal end 655a. Terminal end 655a may be polished to an inclined surface of about 0 to 5° from a vertical plane. In other words, the terminal end 655a may be set to an incline that deviates about up to 5° from if it had been cut as a blunt end. Inclined terminal end 655a may further include an anti-reflecting (AR) coating (not shown) of suitable thickness and material to ensure high return loss.

As shown, terminal end 655a may be complementary angled with terminal end 629a, such that each terminal end has a similar inclined surface in the opposite direction, making the terminal end 655a parallel to terminal end 629a. Thus, the inclined angle of these two surfaces (i.e., 629a, 655a) may be set to make sure that the return loss of the overall component is larger (greater) than the desired threshold.

In some non-limiting aspects or embodiments, SMF 620, second inner housing 622, second intermediate housing 634 and second micro-lens 655 form a SMF collimator 644. These components may be aligned and fixed together via a suitable fastening means, such as epoxies, mechanical fasteners, welding, etc.

Both the HCF collimator 642 and the SMF collimator 644 may be positioned into outer housing 640 via a fastening means after they are aligned. Consequently, the outer housing 640 surrounds at least a portion of the first intermediate housing 632 and at least a portion of the second intermediate housing 634.

Also shown in FIG. 6, is a diagonal prism 660 positioned in between the HCF collimator 642 and the SMF collimator 644. In some non-limiting aspects or embodiments, the diagonal prism 660 includes two non-parallel end faces, proximate to the HCF collimator 642 and the SMF collimator 644, respectively. The diagonal prism 660 may be configured to improve lateral offset and/or angular mismatch between the HCF collimator 642 and the SMF collimator 644. In some non-limiting aspects or embodiments, diagonal prism 660 is sized (e.g., diameter) so that it is equal to or larger than the diameter of micro-lenses 650, 655, thereby ensuring that all the energy of the optical beam is passing through prism 660. In some embodiments, the size of diagonal prism 660 is be set be smaller than the outer diameter of the intermediate housing 634 and 632, or the inner diameter of outer housing 640 to facilitate assembling, for example.

In some embodiments, the diagonal prism 660 may be configured to be positioned at a location within the outer housing 640 that minimizes insertion loss. For example, diagonal prism 660 may be moved along the horizontal axis (e.g., laterally shifted a distance) to fine tune the insertion loss of the connector 600 to a lowest or desired value.

Micro-lenses 650, 655 may be configured to convert and/or adapt a mode field diameter of the SMF 620 and/or HCF 610, thereby promoting mode field diameter match between the SMF 620 and HCF 610. This may be achieved by placement of micro-lenses 650, 655 in between the SMF 620 and HCF 610 and/or through lens, curvature and size selection, etc.

By introducing micro-lenses and inclined surfaces, the mode field diameter matching condition between the SMF 620 and HCF 610 can be met and the requirement of low insertion loss and high return loss can be simultaneously realized. For example, low insertion loss on the range of about ≤0.5 dB and/or high return loss on the range of about ≥50 dB for a center wavelength of about 1310 nm may be achieved.

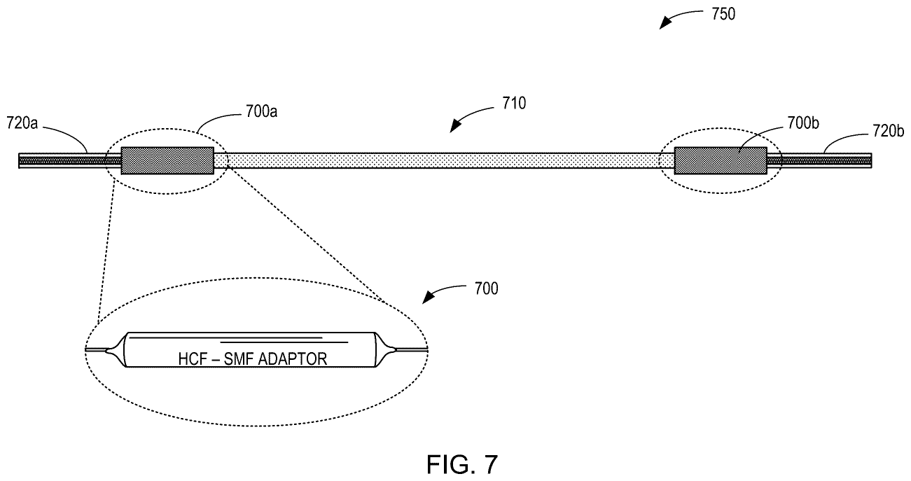

Turning now to FIG. 7, a system 750 with two SMF-HCF connectors 700, in accordance with the principles of the disclosure, is shown. In FIG. 7, system 750 includes a first SMF 720a in communication with a first SMF-HCF connector 700a, in communication with a HCF 710, in communication with a second SMF-HCF connector 700b, in communication with a second SMF 720b. FIG. 7, a close-up of a connector 700 is also provided.

It is to be understood that the invention may assume various alternative variations, except where expressly specified to the contrary. It is also to be understood that the specific devices illustrated in the attached drawings, and described in the specification, are simply exemplary embodiments of the invention. Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope thereof. For example, it is to be understood that the present invention contemplates that, to the extent possible, one or more features of any embodiment can be combined with one or more features of any other embodiment. The embodiments of the invention described herein above in the context of the preferred embodiments are not to be taken as limiting the embodiments of the invention to all of the provided details thereof, since modifications and variations thereof may be made without departing from the spirit and scope of the embodiments of the invention.

1. A hollow core fiber (HCF) and single mode fiber (SMF) coupling system comprising:
a HCF that is positioned in a first inner housing;
a SMF that has been exposed to thermal expanded core (TEC) treatment and is positioned in a second inner housing, wherein the SMF is in tandem with the HCF in the first inner housing; and
a first and a second inner housing.

2. The coupling system of claim 1, further comprising:
an outer housing that surrounds at least a portion of the first inner housing and second inner housing.

3. The coupling system of claim 2, wherein the outer housing comprises a tube or ferrule.

4. The coupling system of claim 1, wherein the first and second inner housing comprise a capillary.

5. The coupling system of claim 2, wherein the SMF and second inner housing comprise a SMF pigtail and wherein the HCF and first inner housing comprise a HCF pigtail, and wherein the SMF pigtail and HCF pigtail are fixed to the outer housing via fastening means after alignment.

6. The coupling system of claim 5, wherein the SMF pigtail comprises a terminal end where the SMF terminates, and wherein the terminal end is polished to an inclined end surface of about 0 to 5° from a vertical plane.

7. The coupling system of claim 6, wherein the terminal end includes an anti-reflective (AR) coating.

8. The coupling system of claim 6, wherein the SMF pigtail has a mode field diameter that is about the same as a mode field diameter of the HCF pigtail.

9. A hollow core fiber (HCF) and single mode fiber (SMF) coupling system comprising:
a HCF that is positioned in a first inner housing;
a SMF and multi-mode fiber (MMF) in communication with each other forming a SMF-MMF system, wherein the SMF-MMF system is positioned in a second inner housing, wherein the SMF-MMF system is in tandem with the HCF in the first inner housing; and
a first and a second inner housing.

10. The coupling system of claim 9, wherein the MMF comprises a graded index multi-mode fiber that has a mode field diameter that is about the same size as a mode field diameter of the HCF.

11. The coupling system of claim 10, wherein the SMF has a mode field diameter, and wherein the MMF expands the mode field diameter of the SMF to about the same as the mode field diameter of the HCF.

12. The coupling system of claim 9, wherein the MMF comprises a graded index multi-mode fiber with length in a quarter the fiber pitch.

13. The coupling system of claim 9, further comprising:
an outer housing that surrounds at least a portion of the first inner housing and second inner housing.

14. The coupling system of claim 9, wherein the SMF-MMF system and second inner housing comprise a SMF pigtail and wherein the HCF and first inner housing comprise a HCF pigtail, and wherein the SMF pigtail and HCF pigtail are fixed to the outer housing via fastening means after alignment.

15. The coupling system of claim 14, wherein the SMF pigtail comprises a terminal end where the MMF terminates, and wherein the terminal end is polished to an inclined end surface of about 0 to 5° from a vertical plane.

16. A hollow core fiber (HCF) and single mode fiber (SMF) coupling system comprising:
a HCF that is positioned in a first inner housing;
a SMF that is positioned in a second inner housing, wherein the SMF is in tandem with the HCF in the first inner housing;
a first micro-lens that is positioned in between the HCF and SMF; and
a first and a second inner housing.

17. The coupling system of claim 16, further comprising:
an outer housing that surrounds at least a portion of the first inner housing and second inner housing, wherein the first micro-lens is positioned in the outer housing.

18. The coupling system of claim 16, wherein the SMF and second inner housing comprise a SMF pigtail and wherein the HCF and first inner housing comprise a HCF pigtail, and wherein the SMF pigtail and HCF pigtail are fixed to the outer housing via fastening means after alignment.

19. The coupling system of claim 18, wherein the SMF pigtail comprises a terminal end where the SMF terminates, and wherein the terminal end is polished to an inclined end surface of about 0 to 5° from a vertical plane.

20. The coupling system of claim 16, wherein the first micro-lens is selected from the group consisting of: c-lenses or single convex lens with tilted plane, graded-index (grin) lenses, d-lenses or biconvex lens, or combinations thereof.

21. The coupling system of claim 20, wherein the first micro-lens is configured to convert and/or adapt a mode field diameter of the SMF and/or HCF, thereby promoting mode field diameter match between the SMF and HCF.

22. The coupling system of claim 16, wherein the coupling system has an insertion loss of about less than or equal to 0.5 dB.

23. The coupling system of claim 16, wherein the coupling system has a return loss of about greater than or equal to 50 dB.

24. The coupling system of claim 16, further comprising:
a first intermediate housing positioned at least partially surrounding the first inner housing and HCF;
wherein the first micro-lens is positioned within the first inner housing proximate to the HCF, and
wherein the HCF, first inner housing, first intermediate housing and first micro-lens comprise a HCF collimator.

25. The coupling system of claim 24, further comprising:
a second intermediate housing positioned at least partially surrounding the second inner housing and SMF; and
a second micro-lens positioned within the second inner housing proximate to the SMF;
wherein the SMF, second inner housing, second intermediate housing, and second micro-lens comprise a SMF collimator.

26. The coupling system of claim 24, wherein the coupling system has an insertion loss of about less than or equal to 0.5 dB.

27. The coupling system of claim 26, further comprising:
an outer housing that surrounds at least a portion of the first intermediate housing,
wherein the first intermediate housing is configured to be positioned at a location within the outer housing that minimizes the insertion loss.

28. The coupling system of claim 25, wherein the first and second micro-lenses are configured to convert and/or adapt a mode field diameter of the SMF and/or HCF, thereby promoting mode field diameter match between the SMF and HCF.

29. The coupling system of claim 25, wherein the SMF and second inner housing comprise an SMF terminal end proximate to the second micro-lens, wherein the SMF terminal end is polished to an inclined end surface.

30. The coupling system of claim 29, wherein the second micro-lens comprises a micro-lens terminal end proximate to the SMF, wherein the micro-lens terminal end is polished to an inclined end surface of about 0 to 5° from a vertical plane.

31. The coupling system of claim 30, wherein the SMF and/or micro-lens terminal ends include an anti-reflective (AR) coating.

32. The coupling system of claim 25, further comprising:
a diagonal prism positioned in between the HCF collimator and the SMF collimator.

33. The coupling system of claim 32, wherein the diagonal prism comprises two non-parallel end faces, wherein the diagonal prism configured to improve lateral offset and/or angular mismatch between the HCF collimator and the SMF collimator.

34. The coupling system of claim 25, wherein the first and second micro-lens are selected from the group consisting of: c-lenses or single convex lens with tilted plane, graded-index (grin) lenses, d-lenses or biconvex lens, or combinations thereof.
